(19) United States
(12) Patent Application Publication
(10) Pub. No.: US 2019/0221348 A1
(43) Pub. Date: Jul. 18, 2019

(54) ELECTROMAGNETIC ACTUATOR

(71) Applicant: Camcon Auto Limited, Cambridge (GB)

(72) Inventor: David Kelly, Warwick (GB)

(21) Appl. No.: 16/329,356

(22) PCT Filed: Sep. 5, 2017
(86) PCT No.: PCT/GB2017/052569

§ 371 Date: Feb. 28, 2019

(30) Foreign Application Priority Data
Sep. 6, 2016 (GB) 1615080.7

(51) Int. Cl. H01F 7/121; H01F 7/08; H01F 7/16; F16H 63/34

(52) U.S. Cl. CPC H01F 7/121; F16H 63/3475; H01F 7/16; H01F 7/081

(57) ABSTRACT

An electromagnetic actuator for use in locking mechanisms comprises a housing, a plurality of coils and an armature which is linearly moveable relative to the housing between two end-of-travel positions by selectively energising the coils of the actuator. The actuator includes a fail-safe mechanism which is operable to urge the armature towards one of the two end-of-travel positions.

### FIELD OF THE INVENTION

The present invention relates to electromagnetic actuators and more particularly, but not exclusively, to actuators for use in locking mechanisms.

### BACKGROUND OF THE INVENTION

Electromagnetic actuators have a wide variety of practical applications. For example, as described in WO-A-2012/069849 (the contents of which are incorporated herein by reference), an actuator may be used to operate a lock assembly for selectively locking the rotational position of a shaft.

### SUMMARY OF THE INVENTION

The present invention provides an electromagnetic actuator comprising a housing; a plurality of coils; an armature which is linearly moveable relative to the housing between two end-of-travel positions by selectively electrically energising the coils of the actuator; and a fail-safe mechanism which is operable to urge the armature towards one of its two end-of-travel positions.

The fail-safe mechanism is provided to ensure that the actuator can be switched to a selected one of its end-of-travel positions even when normal operation of the actuator is not possible. The development of a fault in the control system for the actuator or a loss of electrical power for the control system may mean that the control system is no longer able to switch the actuator. The addition of a fail-safe mechanism ensures that in such circumstances it is still possible to switch the actuator into an end-of-travel position which corresponds to a safe mode for the mechanism which is actuated by the actuator.

The armature of the actuator may be moveable relative to the housing between two or more stable rest positions in which the armature is retained by magnetic and/or mechanical forces alone. Thus, the armature may be held in each stable rest position without needing a coil of the actuator to be energised, thereby minimising the power consumed by the actuator.

The armature may comprise a permanent magnet.

When the fail-safe mechanism is operated or triggered, it urges the armature towards a specific one, and only one, of the two end-of-travel positions of the armature. This ensures that the armature is urged towards the desired end-of-travel position. The fail-safe mechanism is not operable to urge the armature towards the other of the two end-of-travel positions.

In preferred embodiments, the fail-safe mechanism comprises a mechanical potential energy store. The use of a mechanical storage system provides a compact and low cost method of storing the required level of energy, relative to an electrical only solution such as a battery or capacitor.

The mechanical potential energy store may comprise a resilient device, such as a spring. For example, it may be an extension, compression, coil, leaf or torsion spring for example.

The actuator may include a release assembly which is operable to trigger the fail-safe mechanism. The release assembly may be switchable from a first configuration to a second configuration, such that switching the release assembly from the first configuration to the second configuration deploys the fail-safe mechanism which then urges the armature towards one of its two end-of-travel positions.

The release assembly may be a mechanically actuated assembly only, to avoid reliance on an electrical power source. It may comprise hydraulic and/or pneumatic components.

The release assembly may be an electrically actuated assembly. Preferably, it may be operated using a control system which is independent of the control system for the mechanism actuated by the actuator.

After it has been deployed, the release assembly may be switchable from its second configuration back to its first configuration to reset it.

The release assembly may comprise a solenoid and a mechanical linkage, wherein the mechanical linkage is switchable by the solenoid from a first arrangement to a second arrangement, such that switching the linkage from the first arrangement to the second arrangement deploys the fail-safe mechanism which then urges the armature towards one of its two end-of-travel positions.

The first configuration of the release assembly may hold the energy store in a storage state in which potential energy is stored in the energy store, and switching the release assembly to its second configuration releases the energy store from the storage state. For example, when the energy store is in the form of a resilient device, the device may be held in a compressed or extended state by the release assembly.

The armature may comprise a shaft which extends in a direction parallel to the direction of the linear motion of the armature, and the shaft is engaged by the fail-safe mechanism when the fail-safe mechanism is deployed so as to urge the armature towards one of its end-of-travel positions. The distal end of the shaft may be engaged directly by the fail-safe mechanism when it is deployed. The shaft may extend through the housing of the actuator for engagement by a fail-safe mechanism provided outside the housing of the actuator.

The present invention further provides a combination of an actuator as described herein with a lock assembly, wherein the lock assembly is switchable by the actuator between locked and unlocked configurations, and the actuator is coupled to the lock assembly such that when the actuator is in the one end-of-travel position the lock assembly is urged towards its locked configuration.

The lock assembly may be a park lock assembly for a vehicle, for example. The lock assembly may be arranged so as to inhibit motion of the vehicle when in its locked configuration.

In some implementations, the lock assembly may be for selectively locking the rotational position of a shaft. For example, when the lock assembly is its unlocked configuration, rotation of the shaft may be unimpeded by the lock assembly, and when the lock assembly is in its locked configuration, rotation of the shaft may be blocked by the lock assembly.

### BRIEF DESCRIPTION OF THE DRAWINGS

Embodiments of the present invention will now be described by way of example and with reference to the accompanying schematic drawings, wherein:

FIGS. 1 to 3 show cross-sectional side views of an actuator embodying the invention in three different configurations; and

FIGS. 4 and 5 are cross-sectional side views of an actuation device in combination with a lock assembly.

### DETAILED DESCRIPTION OF THE DRAWINGS

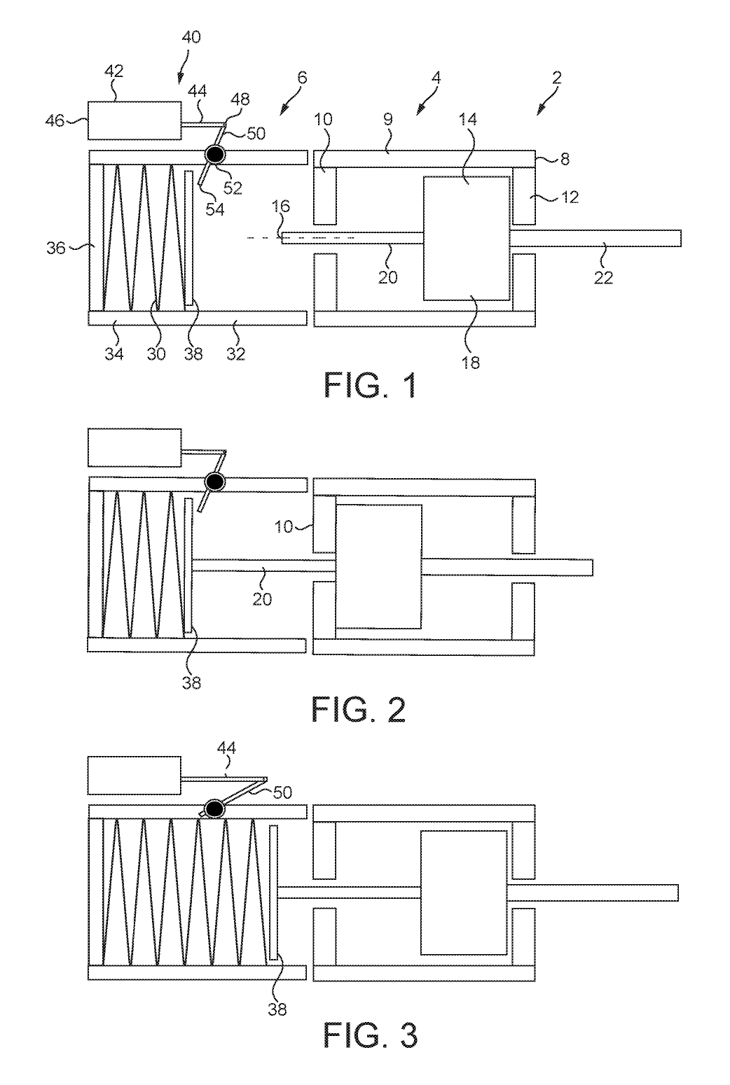

FIGS. 1 to 3 show an electromagnetic actuator 2 in accordance with the present disclosure. A simplified representation of the actuator is shown in the drawings for the purposes of clarity.

The actuator comprises an actuation device 4 in combination with a fail-safe mechanism 6. It will be appreciated that the actuation device 4 may take a variety of forms. For example, it may be a bistable linear actuator as described for example in United Kingdom Patent Publication Nos. 2342504 and 2380065, International Patent Publication No. W02010/067110, or U.S. Pat. No. 6,598,621, the contents of which are incorporated herein by reference.

As shown schematically in FIGS. 1 to 3, actuation device 4 comprises a housing 8 which includes two end caps 10 and 12, at opposite ends of a cylindrical tube 9.

An armature 14 is linearly moveable relative to the housing along a central axis 16. The cylindrical tube 9 is located coaxially relative thereto. The armature comprises an armature body 18 and two coaxially located (in relation to each other and the body 18) shafts 20 and 22. The shafts extend from axially opposite ends of the armature body 14 through respective openings in end caps 10 and 12. The actuation device includes a plurality of coils (not shown in the Figures). The armature is moveable between two end-of-travel positions by selectively electrically energising the coils in a known manner.

The fail-safe mechanism 6 is mounted on one end of the housing of the actuation device, adjacent to end cap 10. It comprises an energy store in a form of a coil spring 30. The spring 30 is provided within a container 32 which comprises a tubular body 34 which is closed at one end by an end closure 36. One end of the tubular body is mounted on the housing 8 of the actuator and the other end is closed by the end closure 36.

One end of the spring 30 bears against the end closure 36 and the other end engages a circular plate 38. The circular plate is able to slide back and forth relative to the container 32 in a direction parallel to the central axis 16. The tubular body 32, the coil spring 30 and the circular plate 38 are located coaxially with the central axis 16 of the actuation device.

A release assembly 40 is mounted on an outer surface of the tubular body 32. It comprises an electrical actuator 42, which may be in the form of a solenoid for example. The actuator 42 includes a rod 44 which extends from its housing 46. The actuator is operable to move the rod in a direction away from or towards the housing. The distal end 48 of the rod is pivotably coupled to a trigger member 50 which may also be in the form of an elongate rod. Trigger member 50 is pivotably and slidably coupled to the tubular body 32 by a pivot 52. The trigger member extends through the wall of the tubular body 32 such that its distal end 54 protrudes beyond the inner wall of the tubular body. In the configuration shown in FIG. 1, the trigger member extends radially inwardly of the tubular body beyond the outer circumferential edge of the circular plate 38. It acts to retain the plate at a fixed axial position along the tubular body and restrains it against the force exerted on the circular plate by the spring 30.

In the configuration of the release assembly 40 shown in FIGS. 1 and 2, it can be seen that the fail-safe mechanism does not impede the normal operation of the actuation device 4. The armature is moveable between the two end-of-travel positions depicted in FIGS. 1 and 2. When the armature is in the end-of-travel position closer to the fail-safe mechanism as shown in FIG. 2, the shaft 20 extends beyond the end cap 10 of the actuation device such that its distal end is close to or in contact with the circular plate 38.

When the fail-safe mechanism is triggered, the release assembly is moved to a second configuration as shown in FIG. 3. The mechanism then urges the armature towards and into its end-of-travel position which is further from the fail-safe mechanism, as depicted in FIG. 3.

The fail-safe mechanism is triggered by actuating the actuator 42. This extends the rod 44 which in turn pivots the trigger member 50 and moves its distal end 54 radially outwards beyond the circumferential edge of the circular plate 38. The coil spring 30 is therefore released and pushes the circular plate 38 towards the actuation device 4. If the armature 14 of the actuation device is not already in the end-of-travel position further from the fail-safe mechanism, the circular plate engages the end of the shaft 20 and thereby pushes the armature towards and into that end-of-travel position.

The configuration of the actuation device 4 may be such that when the armature is within a certain distance of the end-of-travel position further from the fail-safe mechanism, the armature is retracted into and retained in that position by magnetic and/or mechanical forces exerted on the armature by the actuator itself. Accordingly, it may be sufficient for the fail-safe mechanism to be able to push the armature far enough to be sufficiently close to the end-of-travel position for the actuation device itself to pull the armature into the end-of-travel position.

As and when normal operation of the actuation device is to be resumed, the fail-safe mechanism may be reset by returning the release assembly 40, spring 30 and plate 38 to the configuration shown in FIGS. 1 and 2.

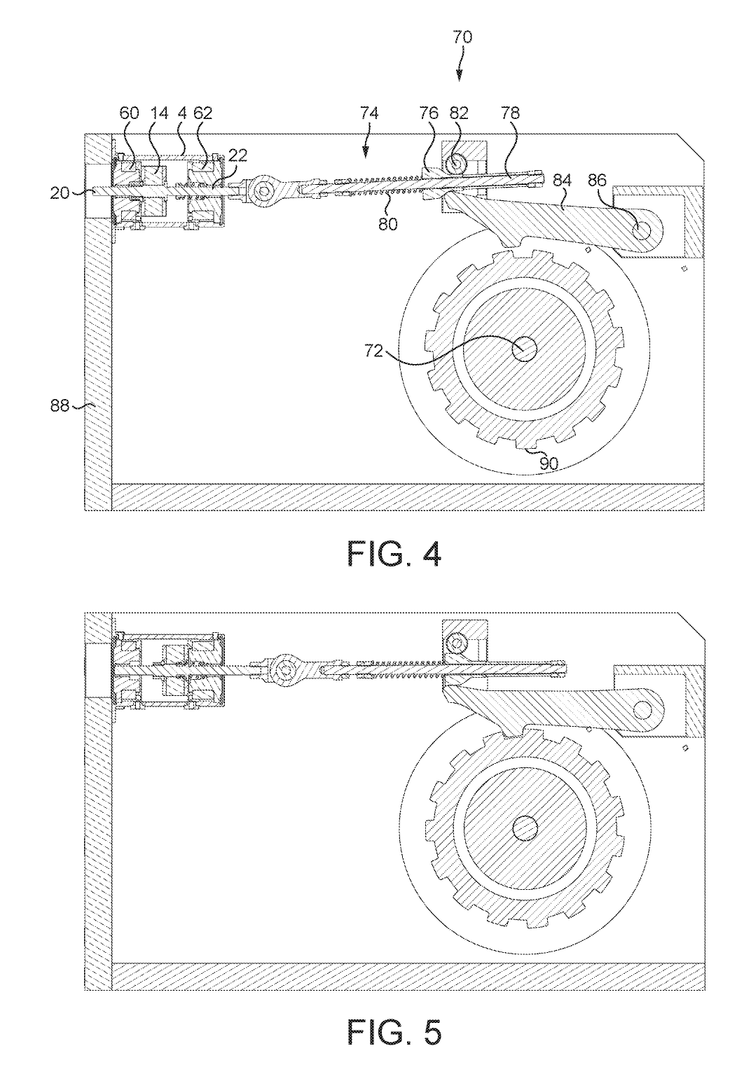

FIGS. 4 and 5 shows an actuation device 4 of the form shown in FIGS. 1 to 3 in combination with a lock assembly 70. In embodiments of the present invention, a fail-safe mechanism 6 is employed in combination with the actuation device 4 as shown in FIGS. 1 to 3.

The actuation device shown in FIGS. 4 and 5 includes coils 60 and 62 towards axially opposite ends of the device. The armature 14 is moveable between end-of-travel positions by selectively electrically energising the coils.

Shaft 22 of the actuation device is connected to a lock assembly 70. The lock assembly is able to selectively lock the rotational position of shaft 72. When the lock assembly is in an unlocked configuration, the shaft is free to rotate. When the lock assembly is in its locked configuration, the shaft is locked against further rotation. When used in an automotive or off-highway transmission, the lock assembly may be employed to lock a shaft directly connected to wheels. For example, it may be deployed as a park lock of the type required with automotive transmissions by legislation in order to provide a positive method of stopping the vehicle from rolling when the power source to the lock is disconnected. The lock assembly may also be used as a shaft lock in industrial machinery that uses rotating components.

Shaft 22 of the actuation device is coupled to a linkage 74 of the lock assembly 70. Linkage 74 includes a cam 76 slidably mounted on a linear support 78. Cam 76 is coupled to a cam spring 80. Cam spring 80 acts to push the cam along support 78 in a direction away from the actuation device 4. Cam 76 is in contact with a pin or roller 82 and the distal end of a pawl 84. Pawl 84 is pivotably mounted on a pivot 86 supported on a casing 88. Pawl 84 is resiliently biased against the cam 76 by a biasing arrangement not shown in FIG. 4.

In FIG. 4, the actuation device has its armature 14 in one of its end-of-travel positions, in which the shaft 22 and the cam 76 are retracted away from pawl 84. In this configuration, the pawl is disengaged from the toothed wheel 90.

In the configuration shown in FIG. 5, the armature of the actuation device has been switched to its other end-of-travel position, causing shaft 22 to push the cam 76 between the pin 82 and the pawl 84. This has pushed the pawl downwardly into engagement with a space between adjacent teeth on the toothed wheel 90. The pawl thereby prevents the shaft 72 from rotating, locking it in position.

In accordance with the present disclosure, a fail-safe mechanism such as the example shown in FIGS. 1 to 3 can be used in association with the actuation device 4. It may be configured to urge the armature 14 of actuation device 4 towards the end-of-travel position shown in FIG. 5 in order to adopt a fail-safe configuration in which the rotational position of the shaft 72 is locked by the lock assembly 70.

1. An electromagnetic actuator comprising:
a housing;
a plurality of coils;
an armature which is linearly moveable relative to the housing between two end-of-travel positions by selectively electrically energising the coils of the actuator; and
a fail-safe mechanism which is operable to urge the armature towards one of its two end-of-travel positions.

2. The actuator of claim 1, wherein the fail-safe mechanism comprises a mechanical potential energy store.

3. The actuator of claim 2, wherein the energy store comprises a resilient device.

4. The actuator of claim 3, wherein the resilient device is a coil spring.

5. The actuator of claim 1, including a release assembly which is operable to trigger the fail-safe mechanism.

6. The actuator of claim 5, wherein the release assembly is switchable from a first configuration to a second configuration, such that switching the release assembly from the first configuration to the second configuration deploys the fail-safe mechanism which then urges the armature towards one of its two end-of-travel positions.

7. The actuator of claim 6, wherein the release assembly is a mechanically actuated assembly.

8. The actuator of claim 6, wherein the release assembly is an electrically actuated assembly.

9. The actuator of claim 8, wherein the release assembly comprises a solenoid and a mechanical linkage, wherein the mechanical linkage is switchable by the solenoid from a first arrangement to a second arrangement, such that switching the linkage from the first arrangement to the second arrangement deploys the fail-safe mechanism which then urges the armature towards one of its two end-of-travel positions.

10. The actuator of claim 6, wherein the fail-safe mechanism comprises a mechanical potential energy store, and wherein the first configuration of the release assembly holds the energy store in a storage state in which potential energy is stored in the energy store, and switching the release assembly to its second configuration releases the energy store from the storage state.

11. The actuator of claim 1, wherein the armature comprises a shaft which extends in a direction parallel to the direction of the linear motion of the armature, and the shaft is engaged by the fail-safe mechanism when the fail-safe mechanism is deployed so as to urge the armature towards one of its end-of-travel positions.

12. A combination of the actuator of claim 1 and a lock assembly, wherein the lock assembly is switchable by the actuator between locked and unlocked configurations, and the actuator is coupled to the lock assembly such that when the actuator is in one end-of-travel position the lock assembly is urged towards its locked configuration.

13. The combination of claim 12, wherein the lock assembly is a park lock assembly for a vehicle.

14. The combination of claim 12, wherein the lock assembly is for selectively locking a rotational position of a shaft.

15. The combination of claim 14, wherein, when the lock assembly is its unlocked configuration, rotation of the shaft is unimpeded by the lock assembly, and when the lock assembly is in its locked configuration, rotation of the shaft is blocked by the lock assembly.
